(19) United States
(12) Patent Application Publication
(10) Pub. No.: US 2012/0313290 A1
(43) Pub. Date: Dec. 13, 2012

(54) PROCESS FOR THE PRODUCTION OF IN PARTICULAR FIBER-REINFORCED THERMOPLASTIC PARTS

(76) Inventors: Georg STEINBICHLER, Rottenmann (AT); Gerhard BAECK, Schwertberg (AT); Peter EGGER, Perg (AT)

(21) Appl. No.: 13/489,720

(22) Filed: Jun. 6, 2012

(30) Foreign Application Priority Data
Jun. 9, 2011 (AT) A 850/2011

(51) Int. Cl. B29C 45/13

(52) U.S. Cl. 264/257; 264/328.6; 425/130

(57) ABSTRACT

A process for the production of in particular fiber-reinforced thermoplastic parts in an injection molding machine, wherein the process includes bringing together a polymeric precursor, an activator and a catalyst, wherein the injection molding machine has a first plasticising screw and a second plasticising screw respectively arranged in a plasticising cylinder, wherein the polymeric precursor and the activator are mixed with the first plasticising screw without addition of the catalyst and are substantially liquefied and the polymeric precursor and the catalyst are mixed with the second plasticising screw without addition of the activator and are substantially liquefied, whereupon the contents liquefied with the two plasticising screws are mixed and jointly introduced into an injection molding mold and substantially only there polymerised to afford the plastic part.

The invention concerns a process for the production of in particular fiber-reinforced thermoplastic parts in an injection molding machine, wherein the process includes bringing together a polymeric precursor, an activator and a catalyst. The invention also concerns an injection molding machine for carrying out such a process.

Such processes have already been known for many years, being known as in situ processes or RTM processes (resin transfer molding). The basic idea therebehind involves mixing polymeric precursors (also referred to as plastic raw components, prepolymers, initial plastic material or the like) with activators and catalysts in a plasticising cylinder (or also in an extruder), in which case then, upon injection of the highly viscous material, it can very easily flow through knitted items, woven items or the like and highly resistant composites or plastic parts are produced in that way. In addition in that way plastic parts of very thin wall thicknesses can be produced, which would not be viable with conventional plastics. The advantage in the production of those thermoplastic parts in relation to the production of thermosetting materials or epoxy resin lies in particular in the shorter hardening time, the high level of impact toughness, the manifold areas of application and better re-usability.

At the present time anionically polymerisable polymers such as for example PA6, PA12, PBT are processed on an industrial scale on reactive installations to give cast polyamide or PBT, which are described diagrammatically in the standard work by Dominghaus, Kunststoffe, 7th edition, Springer Verlag. The initial materials are present in liquid form in heated containers and are conveyed into a mixing head by way of precision pumps. Frequently both components also circulate in the circuit to the mixing head and the latter takes material from both circuits only during the metering phase, mixes that material in a metering chamber and then discharges it. With that process the two initial substances are at a high temperature for a prolonged time, which on the one hand involves limitations in regard to the raw materials which can be used and on the other hand causes reactivity to reduce in the course of time. In addition material conversion procedures are time-consuming and involve comparatively large wastage quantities. In the case of conventional reactive installations the two components (for example polyol and isocyanate) circulate at a constant pressure level. For the operation of injection into the mold the two molten material flows are combined in the mixing head and diverted into the tool. Typically injection is effected at a constant rate.

The state of the art in EP 1 415 793 A1 describes a heated plasticising unit with an intermediate buffer and a horizontally arranged screw system is shown. The latter is not suitable in that arrangement for plasticising extremely viscous caprolactam or other initial substances for reactive injection molding as those highly viscous materials run in the direction of the intake zone between the screw flight and the mass cylinder and there form lumps with the granular material. For reactive systems, a reservoir in combination with a piston discharge system is only limitedly feasible by virtue of possible polymerisation in the reservoir or the piston head chamber.

A similar approach is implemented in WO 02/18120 A2, wherein molten material is conveyed into the tool by a horizontally arranged plasticising unit directly with a discharge piston.

WO 2011/006648 A1 describes a vertically arranged injection assembly with a reverse flow block and subsequent addition of a second component. A disadvantage with this variant is the relatively great structural height. In addition in this variant a supplied activator or catalyst also has to be continuously kept so-to-speak ‘on the boil’.

Therefore the object of the present invention is to provide a process for the production of thermoplastic parts, that is improved over the state of the art. In particular the invention seeks to provide that the injection molding machine is operated as efficiently as possible and is used flexibly, while also as little energy as possible is to be necessary for melting and providing the basic components.

For a process having the features of the classifying portion of claim 1, that object is attained in that the injection molding machine has a first plasticising screw and a second plasticising screw respectively arranged in a plasticising cylinder, wherein the polymeric precursor and the activator are mixed with the first plasticising screw without addition of the catalyst and are substantially liquefied and the polymeric precursor and the catalyst are mixed with the second plasticising screw without addition of the activator and are substantially liquefied, whereupon the contents liquefied with the two plasticising screws are mixed and jointly introduced into an injection molding mold and substantially only there polymerise to afford the plastic part. Thus the components required for polymerisation can be melted and mixed always in specifically targeted fashion and only when they are required so that there is no need for constantly holding in readiness components which have already been liquefied and partially mixed. A further advantage is that the supplied activators or catalysts are respectively kept in the plasticising cylinder at a temperature at which they are just liquefied but do not yet trigger polymerisation or trigger very slight and insignificant polymerisation. ‘Substantially liquefied’ means that the major part of the introduced components has already gone into the liquid aggregate state in the plasticising cylinder, but a small part (below 5%) of the components can also only later go into a liquid state. The statement that the contents which are brought together ‘substantially only’ polymerise in the injection molding mold means that the first initiation steps for complete polymerisation can already be very well triggered by the activators or catalysts prior to the injection molding mold, but the essential steps of polymerisation (gel effect and glass effect) take place only in the injection molding mold.

In a preferred embodiment of the invention it can be provided that mixing of the contents is effected in a mixing chamber preferably arranged in the injection molding mold. The contents can be introduced into that mixing chamber through a flexible hose from the injection assemblies. It is however also possible for the injection assemblies to be connected to the injection molding mold by way of a static injection passage.

To be able to dispense with injection pumps or other pressure means, it can preferably be provided that introduction of the polymeric precursor together with catalyst and activator into the injection molding mold is effected by advance of both plasticising screws. In that case the screw advance speeds can be synchronised (axis coupling). In addition it is possible to implement an injection profile for adaptation to the tool geometry, which is not possible in the case of constant-pressure pumps or is possible therewith only at a great deal of complication and expenditure.

The addition of the activator or catalyst can be directly into the mass cylinder (high pressure injection) to be able to avoid at a downstream location static mixing systems which are difficult to clean. It will be noted however that it is preferably provided that the activator is added to the polymeric precursor prior to filling to the first plasticiser screw and the catalyst is added to the polymeric precursor prior to filling to the second plasticiser screw. The metering operation in the individual plasticising cylinders can be effected in that case for a single injection procedure. It is however also possible to perform a plurality of successive injection procedures without additional metering addition. Optionally, it is also possible to provide positively closing blocking means or closure nozzles between the thrust screw and the mixing head.

In principle the polymer products can be monomers or oligomers. It is particularly preferably provided in that respect that ε-caprolactam and/or laurolactam or cyclic butylene terephthalate is used as the polymeric precursor.

A thermoplastic part of polyamide 6 is produced with caprolactam. In that case an aliphatic polyisocyanate or a blocked diisocyanate can be used as the activator. In the production of polyamide 6 metal lactamates of sodium, potassium or bromomagnesium can be used as the catalyst. Preferably sodium caprolactamate is used. The activators have a proportion in percent by weight of between 0.09 and 0.45% and the catalysts have a proportion in percent by weight of between 0.17 and 0.51% active substance in relation to the total mass to be injected.

A polyamide 12 is produced with laurolactam is the polymeric precursor. In that case sodium lactamate, alkali laurolactamates or sodium caprolactamate (C10) can be used as catalysts. Possible activators in the production of polyamide 12 are carbodiimides, N-acyl laurolactams, blocked or unblocked isocyanates (C20). In the production of polyamide 12 the joint proportion of the activators and catalysts is about 0.4% by weight (activator and catalyst both contain just 20% of active substance, therefore the 0.4% by weight correspond to 2% addition of activator and catalyst present in caprolactam). In addition laurolactam can be copolymerised with ε-caprolactam, styrene and ε-caprolactone.

Cyclic butylene terephthalate serves as a starting plastic material or polymeric precursor for a plastic part of polybutylene terephthalate (PBT). Polymerisation is then effected with a catalyst/activator and at a suitable temperature. For example the tin-based catalyst obtained by transesterification, Fascate 4101 from Arkema, with the chemical formula BuSnCl(OH)2 can be used as the catalyst with a 0.45 percent by weight additive amount.

It can particularly preferably be provided that arranged in the injection molding mold prior to the injection operation is a component which is to have material injected therearound, preferably a flat textile article or the like, which after the injection operation and polymerisation of the injected polymeric precursor together with activator and catalyst also forms a fiber-reinforced plastic part. The flat textile article or fiber item can be formed for example by crocheted fabrics, knitted fabrics, long fibers, endless fibers, glass fibers, carbon fibers, aramide fibers, mats, non-woven fabrics, braids, woven fabrics or fleece fabrics.

In a preferred embodiment of the invention the processing of temperature-sensitive additives like natural fibers is also possible. The additive substances which are preferably soluble or which are of a maximum diameter that can pass through a mixing head are either added to the mass cylinder by way of the main filling opening or are introduced into the mold in the form of reinforcing structures like for example non-woven fabrics, knitted fabrics, crocheted fabrics or randomly laid fiber mats. Alternatively it would be possible for example to add larger filling substances with a stuffing unit or endless rovings between the mixing head and the mold. In thermoplastic injection molding materials are typically processed markedly above the melting temperature (about 20-100° C. higher). That limits the use of thermally sensitive natural fiber materials (for example wood fibers, regenerate cellulose, hemp, flax, jute, sisal, . . . ) to low-melting matrix materials. The latter also have low long-term use temperatures. For example PA6 can be polymerised at 160° C. by means of anionic polymerisation by means of reactive injection molding. That is still markedly below the decomposition temperatures of the natural fiber constituent lignin.

In order now also to obtain protection for an installation for carrying out a process protection is claimed for an injection molding machine as set forth in claim 9. Such an injection molding machine includes a first plasticising screw for liquefying and mixing a polymeric precursor with an activator, a second plasticising screw for liquefying and mixing a polymeric precursor with a catalyst, a mixing chamber for mixing the contents liquefied with the two plasticising screws, an injection molding mold in which the contents mixed in the mixing chamber can be jointly introduced and polymerised, and a control or regulating unit having a data store, wherein stored in the data store are injection profiles or process steps for carrying out the process as set forth in one of claims 1 through 8.

A great advantage of such an injection molding machine over a conventional reactive installation is that the introduced components are not subject to any recirculation. In addition the fast response on the part of the preferably electric injection assemblies is put to use. A further advantage lies in the possibility of axis synchronisation and/or in implementing an injection profile. It can preferably be provided in that respect that arranged between the plasticising screws and the mixing chamber are respective feed lines for the liquefied contents, wherein measuring sensors measure the pressure in the feed lines and a corresponding signal can be fed to the control or regulating unit. It can particularly preferably be provided that the injection molding machine can be controlled or regulated by the control or regulating unit in dependence on the stored injection profiles or process steps and/or the signals supplied by the measuring sensors. That affords control or regulation, which is adapted to the wishes of the user, of the thrust screw forward movement speed in dependence on the pressure signal in the molten material feed line between the screw end and the mixing apparatus or in dependence on the stored injection profiles.

It can also be provided in terms of regulation that actuation of the optional closure nozzles is effected in dependence on the pressure level in the screw head chamber or in the mixing head. It is also possible to provide for differential measurement whereby opening is effected only at the minimum pressure level and closure is effected after the work is done. There can also be a coupling to pressure signals from the mold tool.

Further details and advantages of the present invention are described more fully hereinafter by means of the specific description with reference to the embodiments by way of example illustrated in the drawings in which:

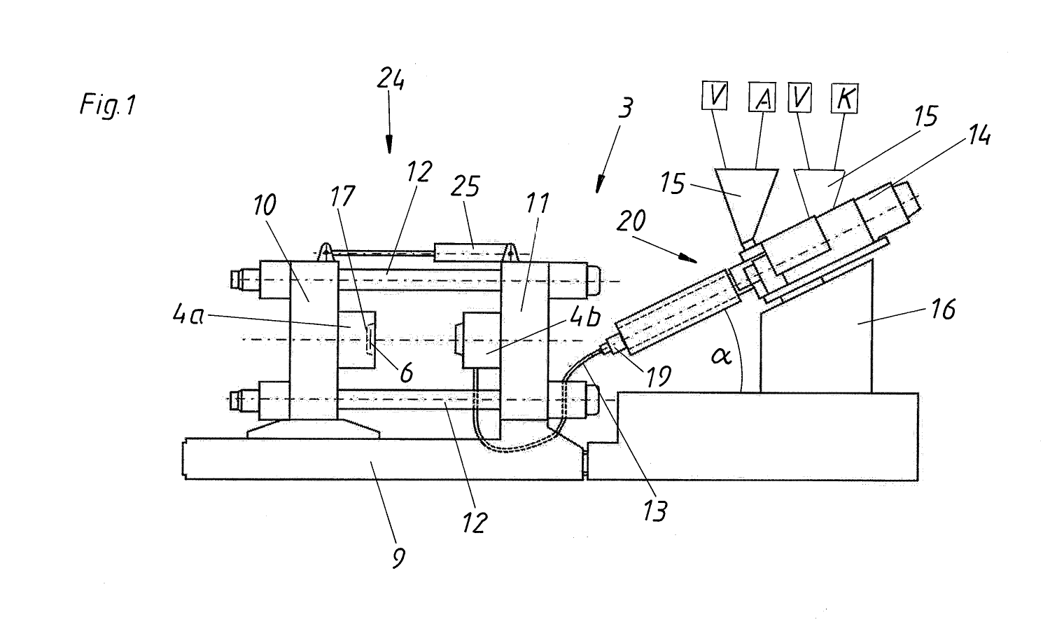

FIG. 1 diagrammatically shows an injection molding machine with closing unit and plasticising unit,

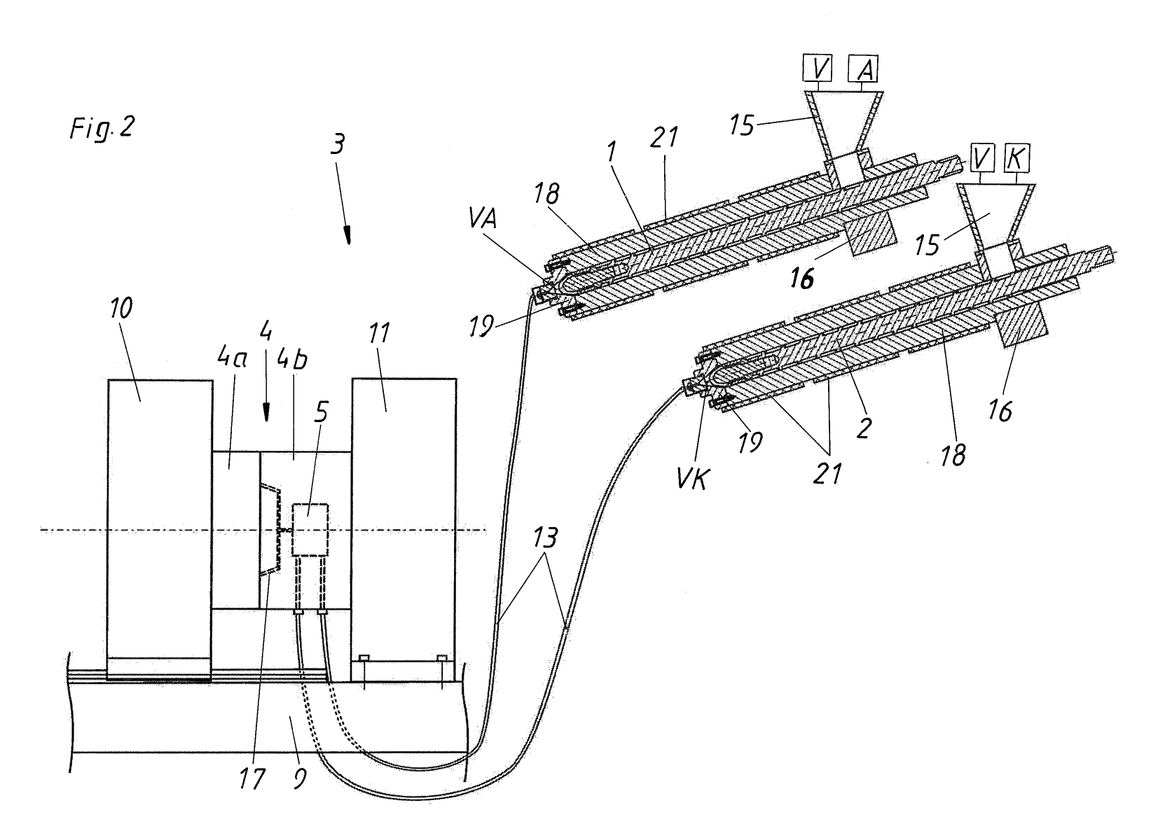

FIG. 2 shows details of the two injection assemblies,

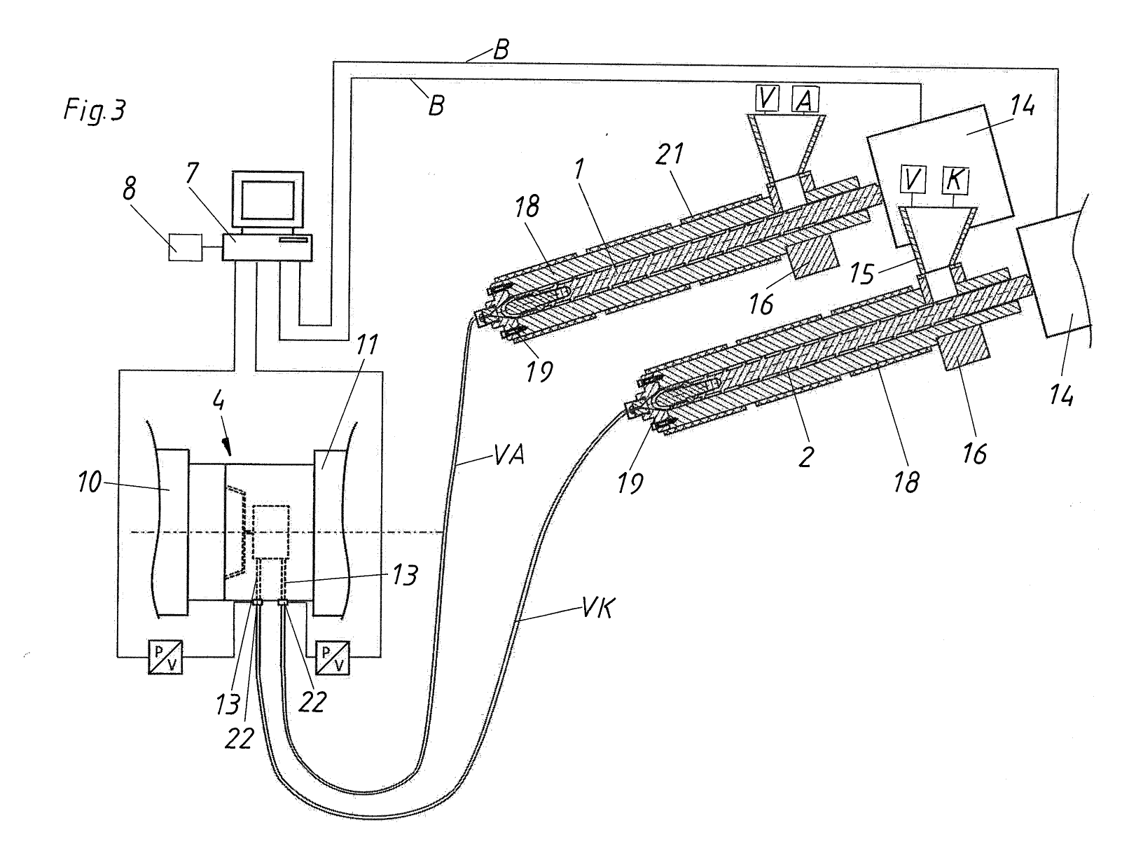

FIG. 3 shows details of the injection assemblies with the control or regulating unit, and

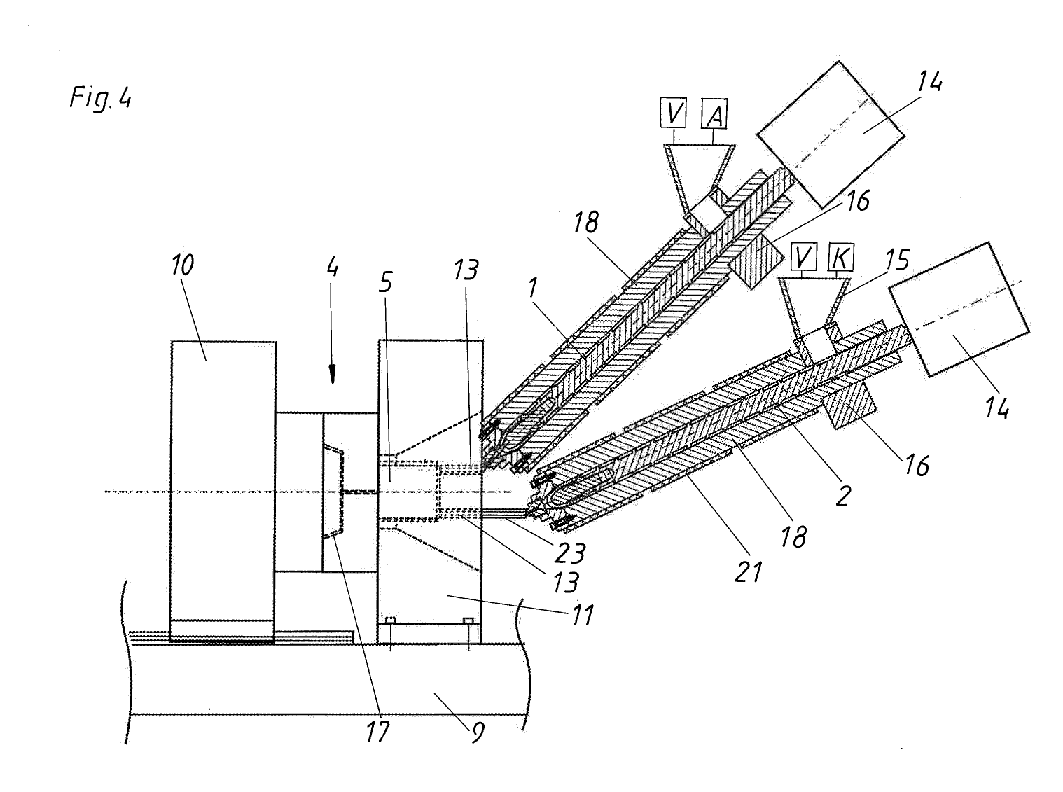

FIG. 4 shows injection assemblies which are set at different angles of inclination with a mixing head outside the tool.

FIG. 1 shows an injection molding machine 3 comprising a closing unit 24 and a plasticising unit 20 both arranged on a frame 9. The closing unit 24 has a fixed mold holding plate 11, a movable mold holding plate 10, frame members 12, the mold halves 4a and 4b of an injection molding mold 4 and a motion device 25 for the movable mold holding plate 10. The injection assemblies of the plasticising unit 20 are connected to the frame 9 by way of an assembly holder 16 and are inclined relative to the horizontal at an angle α of in this case 25°. Because of the view in FIG. 1, only one plasticising or injection assembly is visible, of the injection assembly therebehind only the filling hopper 15 and the diagrammatically illustrated introduction of the polymeric precursor V and the catalyst K is indicated. The mixed and liquefied contents VA and VK pass into the injection molding mold 4 by way of the injection nozzle 19 and the feed line 13, and can there form a fiber-reinforced plastic part by the injection of material around the component 6 to be injected around, after polymerisation. To permit the reinforcing structures or insert parts to be inserted as easily as possible the injection molding mold 4 can also be arranged in a vertically movable closing unit 24.

FIG. 2 shows the closing unit 24 in the closed position whereby the cavity 17 is formed in the injection molding mold 4. Provided in a mold half 4b of the injection molding mold 4 is the mixing chamber 5 into which the two feed lines 13 of the two injection assemblies lead. A polymeric precursor V and an activator A are introduced into the injection assembly with the plasticising screw 1 by way of the filling hopper 15 and are jointly liquefied in the plasticising cylinder 18 by the plasticising screw 1. The plasticising cylinder 18 is surrounded by heating bands 21. In the front region of the plasticising screw 1 the liquefied content VA passes into the region of the injection nozzle 19. From there that injection assembly is connected to the mixing chamber 5 by way of the feed line 13. A cleaning thrust rod can also be passed into the mixing chamber 5 and cleans the mixing chamber 5 after mixing and injection have occurred so that residues which have remained behind there do not cause any polymerisation, whereby the mixing chamber 5 could otherwise become blocked.

A polymeric precursor V and the catalyst K are introduced into the injection assembly with the plasticising screw 2 by way of the filling hopper, liquefied jointly by means of the plasticising screw 2 and also passed into the mixing chamber 5 as liquefied content VK by way of the feed line 13. The two feed lines 13 are in the form of flexible heated hoses. The contents VA and VK pass by way of the slightly rising arrangement of the hoses (feed line 13) into the mixing chamber 5 to be filled. In that case the mixing operation can preferably be so effected that the mixing nozzles arranged at the ends of the feed line 13—in contrast to the illustrated view—are directed directly towards each other and thus this involves turbulent thorough mixing of the contents VA and VK. Alternatively it would be possible to use a mixing chamber 5 with an agitator mechanism which however entails the disadvantage of the increased cleaning complication and greater waste quantities.

The introduced contents are heated to up to 120° C. in the injection assemblies in the production of polyamide 6. In the production of polyamide 6 in contrast a temperature of about 160° C. obtains in the injection molding mold 4. When the individual contents VK and VA are sprayed together through two preferably bored holes of about 0.6 mm in diameter or through two wide-slot nozzles for example 10 cm³ per plasticising screw 1 and 2 respectively is introduced per second into the mixing chamber 5. If that filling operation is effected for about 10 seconds, then 200 cm³ of material to be polymerised passes into the mixing chamber 5 and directly further into the cavity 17 in the injection molding mold 4. The mixing chamber 5 can be cylindrical and can be of a diameter of 10 mm and a length of 50 mm. The contents VA and VK are in the mixing chamber 5 for less than a second, preferably for about 0.2 second. After that they pass directly into the injection molding mold 4 and polymerise there in between about 2 and 10 minutes. There is no need to cool the mold halves 4a and 4b down from 250° C. to the mold removal temperature due to polymerisation at about 160° C. That gives particular energy efficiency as the injection molding mold 4 only has to be heated up once and can then be kept at a constant temperature. In addition there is no damage to the additives, as is otherwise to be feared at about 250° C. A further advantage is the low pressures (maximum of 100 bars before passing into the mixing chamber 5) and the low torque requirement of the plasticising assemblies. As the low pressures mean that no or only a slight displacement of introduced components 6 (reinforcing fibers) or destruction of a woven article is to be feared the present invention affords a substantial improvement for lightweight construction capable of large-series manufacture. The low closing force requirement also contributes to better energy efficiency. For example, in the production of plastic parts with caprolactam, the internal mold pressure is about 0.7 bar.

In addition to FIG. 2, FIG. 3 also shows the control or regulating unit 7 together with the data store 8. Arranged in the feed line 13 are respective measuring sensors 22 which pass a pressure signal P/V to the control or regulating unit 7. In addition for example injection profiles or other process steps are stored in the data store 8. Commands B are delivered to the drive units 14 of the two injection assemblies by way of the control or regulating unit 7 in dependence on the supplied signals or stored data in the data store 8. That permits precise control and injection and thus specifically targeted production of plastic parts.

FIG. 4 shows a Y-shaped arrangement of the injection assemblies to achieve molten material travel paths which are as short as possible as the injection nozzles 19 open directly into the rigid feed lines 13 which are partly provided in the movable mold holding plate 11. Those feed lines 13 can be surrounded by a heating element 23.

It can particularly preferably be provided according to the invention that the two plasticising screws 1, 2 are inclined relative to the horizontal at an angle a of between 7° and 50°, preferably between 10° and 35°. The fact that the at least two injection assemblies are inclined at an angle to the horizontal means that it is possible on the one hand to guarantee a structural height which is as small as possible. On the other hand, the inclination provides that the molten and highly viscous material (for example 4 mPa·s in the case of caprolactam) does not flow back between the screw flights and the plasticising cylinder 18. Lump formation with the introduced granular material or the formation of a molten sea of caprolactam which extends far into the granular material bed and there leads to lump formation are avoided. In regard to the inclined positioning the individual injection assemblies can be in the same angular position or also in mutually different angular positions (see FIG. 4).

It will be appreciated that basically the provision of more than two injection assemblies should not be excluded. In that respect it would be possible for example for the pure polymeric precursor V to be melted in a third injection assembly while the polymeric precursor V and the activator A on the one hand and the polymeric precursor V and the catalyst K on the other hand are liquefied in the other two assemblies. Those three liquefied contents VA, VK and V can only then be brought together in a mixing chamber 5. In that respect it should also be mentioned that a mixing chamber 5 does not necessarily have to be provided. Rather mixing of the individual contents VA and VK can also first be effected in the cavity 17 or in its feed passage.

It can preferably further be provided that inert gas or nitrogen is supplied in the region of the filling hopper 15. That makes it possible to keep moisture away. Conventional feed devices for the polymeric precursors V, activators A or catalysts K which are in granule form or which are partially already fluid can be provided for introducing the components into the filling hopper 15 or directly into the screw cavity in the plasticising screw 18. Those feed devices are not shown in the drawings.

In principle it is not necessary for the same polymeric precursor V to be introduced into the different injection assemblies, but it is also possible for different polymeric precursors V to be introduced into the at least two injection assemblies. Mixtures of polymeric precursors V however can also be introduced into at least one of the injection assemblies.

The at least two injection assemblies afford on the one hand the advantage that it is possible to implement an injection profile. That is not possible in the case of pumps with a constant delivery. On the other hand, when using pumps, the material stands for quite long whereas with the present invention the material can be passed relatively cool into the filling hopper 15 and is only plasticised when required. Therefore there is no need for the basic components to be kept ‘on the boil’. That always guarantees reactivity of the introduced components. A faster change in material can also be effected. In addition no lines have to be washed, in comparison with high-pressure installations. Furthermore the time for conversion to new components is substantially shorter.

1. A process for the production of in particular fiber-reinforced thermoplastic parts in an injection molding machine, wherein the process includes bringing together a polymeric precursor, an activator and a catalyst, characterised in that the injection molding machine has a first plasticising screw and a second plasticising screw respectively arranged in a plasticising cylinder, wherein the polymeric precursor and the activator are mixed with the first plasticising screw without addition of the catalyst and are substantially liquefied and the polymeric precursor and the catalyst are mixed mixed with the second plasticising screw without addition of the activator and are substantially liquefied, whereupon the contents liquefied with the two plasticising screws are mixed and jointly introduced into an injection molding mold and substantially only there polymerised to afford the plastic part.

2. A process as set forth in claim 1 characterised in that mixing of the contents is effected in a mixing chamber preferably arranged in the injection molding mold.

3. A process as set forth in claim 1 characterised in that introduction of the polymeric precursor together with catalyst and activator into the injection molding mold is effected by advance of both plasticising screws.

4. A process as set forth in claim 1 characterised in that the activator is added to the polymeric precursor prior to filling to the first plasticising screw.

5. A process as set forth in claim 1 characterised in that the catalyst is added to the polymeric precursor prior to filling to the second plasticising screw.

6. A process as set forth in claim 1 characterised in that ε-caprolactam and/or laurolactam or cyclic butylene terephthalate is used as the polymeric precursor.

7. A process as set forth in claim 1 characterised in that arranged in the injection molding mold prior to the injection operation is a component which is to have material injected therearound, preferably a flat textile article or the like, which after the injection operation and polymerisation of the injected polymeric precursor together with activator and catalyst also forms a fiber-reinforced plastic part.

8. A process as set forth in claim 1 characterised in that at least two plasticising screws are used, which are arranged inclinedly relative to the horizontal at an angle (α) of between 7° and 50°, preferably between 10° and 35°.

9. An injection molding machine comprising
a first plasticising screw for liquefying and mixing a polymeric precursor with an activator,
a second plasticising screw for liquefying and mixing a polymeric precursor with a catalyst,
a mixing chamber for mixing the contents liquefied with the two plasticising screws,
an injection molding mold in which the contents mixed in the mixing chamber can be jointly introduced and polymerised, and
a control or regulating unit having a data store, wherein stored in the data store are commands for process steps for carrying out the process as set forth in claim 1.

10. An injection molding machine as set forth in claim 9 characterised in that the two plasticising screws are inclined relative to the horizontal at an angle (α) of between 7° and 50°, preferably between 10° and 35°.

11. An injection molding machine as set forth in claim 9 characterised in that arranged between the plasticising screws and the mixing chamber are respective feed lines for the liquefied contents, wherein measuring sensors measure the pressure in the feed lines and a corresponding signal can be fed to the control or regulating unit.

12. An injection molding machine as set forth in claim 9 characterised in that the injection molding machine can be controlled or regulated by the control or regulating unit in dependence on the stored commands for process steps and/or the signals supplied by the measuring sensors.
